(19) United States
(12) Patent Application Publication
(10) Pub. No.: US 2010/0048076 A1
(43) Pub. Date: Feb. 25, 2010

(54) DEPOSITION OF PARTICLES ON A SUBSTRATE

(75) Inventors: Yves L. M. Creyghton, Delft (NL); Timo Huijser, Zoetermeer (NL); Marino Emanuela, Delft (NL)

Correspondence Address: RENNER OTTO BOISSELLE & SKLAR, LLP, 1621 EUCLID AVENUE, NINETEENTH FLOOR, CLEVELAND, OH, 44115, US

(73) Assignee: Nederlandse Organisatie voor toegepast - natuurwetenschappelijk onderzoek TNO, Delft (NL)

(21) Appl. No.: 12/521,002

(22) PCT Filed: Dec. 27, 2007
(86) PCT No.: PCT/NL2007/050705

§ 371 Date: Jun. 24, 2009

(30) Foreign Application Priority Data
Dec. 28, 2006 (EP) 06077331.4

(51) Int. Cl. B32B 5/02; H05H 1/24; B32B 5/16

(52) U.S. Cl. 442/135; 427/561; 427/535; 427/562; 442/59

(57) ABSTRACT

The invention is directed to a method for depositing particles on a substrate and to a fibrous web comprising deposited particles. A method is provided according to which particles are provided on a surface activated substrate by means of a plasma treatment. The method comprises the subsequent steps of -providing particles, preferably coating said particles; -subjecting said particles to a first plasma treatment before being deposited on said substrate; and -depositing said particles on said surface of said substrate, preferably using a second plasma treatment.

The invention is directed to a method for depositing particles on a substrate and to a fibrous web comprising deposited particles.

The provision of particles on a substrate can confer a number of important benefits, such as increased or reduced friction of the substrate, selective gas adsorption or permeation of gases (for gas sensor and gas membrane applications), catalytic reactivity (antimicrobial coatings, catalytic reactors) or liquid repellence, that depend on factors such as the physical and chemical properties of the binding material (often a polymer film), the nature of the particles and their concentration.

Most conventional techniques for depositing particles on a substrate are based on thin film deposition using either wet processing (dip coating) or gas phase methods such as physical vapour deposition (e.g. sputtering, evaporation) or chemical vapour deposition (e.g. photochemical or plasma enhanced CVD).

A major disadvantage of the known techniques is that besides the particles a relatively large amount of binder material is deposited. The binder material results in a coating that often covers the entire surface of the substrate and thereby will change the surface properties of the substrate. For instance when the substrate is a fibrous web, properties such as flexibility and breathability can be significantly changed if the fibres are coated with binder material. In addition, the excess binder material results in an often undesirable weight increase of the substrate. Thus, it is often desirable to only introduce the properties of the particles on the surface of the substrate and not, or to a much lesser extent, the properties of the binder material.

Other drawbacks of wet processing techniques include the amount of processing steps, the difficulty to deposit very thin layers or to deposit on predetermined (small) localised areas, the use of chemicals, and the limited process speed which leads to relatively long process times.

GB-A-2 353 960 describes a method for depositing ceramic particles onto a substrate to improve puncture resistance. The ceramic particles are mixed with an organic carrier to form a ceramic loaded composite. The composite can then be coated on the substrate material by conventional wet processing techniques such as dipping, painting or spraying.

Conventional gas phase deposition methods suffer from complexity of operation and long process time due to low deposition rates and the use of vacuum equipment. In the special case of particle deposition, a suitable gas phase method for particle dispersion on the surface (e.g. sputtering, metal evaporation) and a separate second method for polymerisation of a precursor gas (e.g. by application of a plasma near the surface) need to be applied simultaneously or in an alternating mode.

In the field of flexible personnel ballistic protection very strong substrates, such as ultra high molecular weight polyethylene and aramide fibers are extensively used due to their high strength and light weight characteristics. In order to increase the protection against more lethal ballistic threats usually more layers of the fibrous material are added or ceramic inserts are applied at the expense of increased weight of the armour and reduced mobility of the wearer.

Lee et al. (J. Mater. Sci. 2003, 38(13), 2825-2833) showed that the ballistic penetration resistance of Kevlar™ fabric (based on para-aramide) can be enhanced by impregnating the fabric with a colloidal shear thickening fluid consisting of silica particles in ethylene glycol. They demonstrated that the energy adsorption is proportional to the amount of shear thickening fluid. In addition, four layers of impregnated Kevlar™ were found to adsorb the same amount of energy as fourteen non-impregnated layers.

Tan et al. (Int. J. Sol. Struct. 2005, 42(5-6), 1561-1576) studied the ballistic penetration resistance of Twaron™ fabric (a material based on aramide) impregnated with silica colloidal water suspension. They demonstrated a significant improvement of the ballistic limit for single, double and quadruple ply systems.

The improvement in ballistic protection of impregnated fabric systems as described by Lee et al. and Tan et al. is achieved at the expense of increased weight. The specific ballistic energy, which is the energy of the projectile at the ballistic limit divided by the areal mass density of the fabric system, is not improved. For thick fabric systems, the ballistic limits and thus the specific ballistic energy of the impregnated fabrics are even reduced when compared to the untreated fabrics.

WO-A-2005/110626 describes a process according to which an active material is mixed with a coating forming material in a plasma environment. The mixture is subsequently deposited onto a substrate. The result is a substrate comprising a coating.

Object of the present invention is to provide a method for depositing particles on a substrate which does not suffer from the above-mentioned disadvantages, such as significant weight increase and undesired change in the properties or characteristics of the substrate.

This object is met by the method of the invention according to which particles are provided on a surface activated substrate by means of a plasma treatment.

Accordingly, in a first aspect the invention is directed to a method for depositing particles on a substrate, comprising the subsequent steps of

providing particles, preferably coating said particles;

subjecting said particles to a first plasma treatment before being deposited on said substrate; and

depositing said particles on said surface of said substrate, preferably using a second plasma treatment.

The method of the invention results in a substrate wherein particles are individually attached to the surface of the substrate without deposition of a binder layer which entirely covers the substrate. As a result, the substrate can be provided with particles with a minimum weight increase of the substrate. In addition, particles can be deposited onto the substrate without introducing undesired surface properties caused by an excess of binder material.

The use of a plasma treatment for depositing a composite film on a substrate is known from WO-A-2006/092614. This patent application describes a method in which a coating material is introduced into a sub-atmospheric pressure plasma prior to and/or when contacting the substrate. However, the method described in this patent application still suffers from undesired weight increase due to excess coating material. Furthermore, the method of this patent application uses a plasma with a sub-atmospheric gas pressure of typically 0.01 to 10 mbar. In contrast to the teaching of WO-A-2006/092614, the present inventors found that it is possible to advantageously use an atmospheric plasma for depositing particles on a substrate.

In addition, the process of the present invention preferably uses different plasma regions for pre-treatment of the particles and for deposition of the particles onto the substrate. This advantageously allows a separate control of the process conditions for particle pre-treatment and particle deposition. Examples of such conditions (which may be very different for particle pre-treatment and deposition) are the gas temperature, the gas composition, the power density (determined by the frequency and distribution of the applied electric field), and the residence time of particles in the plasma region, related to the typical time scales of the chemical reactions involved. The separate control of the process conditions for particle pre-treatment and particle deposition gives sufficient control of favourable properties of the particles prior to deposition such as: surface activation of particles improving adhesion, coating of particles (so as to improve chemical compatibility or avoid chemical decomposition during plasma-assisted deposition, providing a binder material which can be an elastomer used to attach particles to the surface, achieve various additional functions via added layers (multi-shell particles), formation of particles either by condensation from the gas phase or evaporation of liquid where the solute forms a solid particle, and/or avoiding agglomeration of particles by (unipolar) electrostatic charging of the particles.

In principle any type of plasma source can be used, but a non-thermal plasma at about atmospheric pressure is preferred. Cost for providing low pressure conditions at the locus of deposition can thus be avoided.

Typical plasma sources include corona discharge, atmospheric pressure glow discharge, microwave discharge, volume filamentary dielectric barrier discharge, volume glow dielectric barrier discharge, plasma jet, micro-hollow cathode discharge, surface dielectric barrier discharge, and coplanar surface dielectric barrier discharge. Any power source, such as continuous high frequency and repetitively pulsed power, may be used to create plasma. It is preferred that the power source is a repetitively pulsed power source, since this allows a better control over plasma chemistry.

Particularly preferred plasma sources are dielectric barrier discharges (DBDs). In the case of surface DBD, the electrode structure of the plasma source comprises a dielectric object supporting two electrodes, where at least one of those electrodes is fully isolated from the plasma by means of that dielectric object. After application of a potential difference between those electrodes an ionizing electric field and plasma is formed in a thin region of the gas in vicinity of that dielectric surface. Coplanar surface DBD is a special case of surface DBD where both electrodes are embedded in a dielectric and are not in direct contact with plasma, thus resulting in a longer lifetime of the electrodes.

Surface DBD plasma sources can generate a high surface density of homogeneously distributed atmospheric pressure plasma filaments which can be continuously reproduced with high repetition rate and minor fluctuations of the spatial structure and plasma power density as a function of time. The thin plasma layer thus formed is very well reproducible in time and very well distributed in space and is not only achieved in rare gases such as helium but, in nearly any gas mixture. Surface DBD is very suitable for the treatment of surfaces and for the treatment of fibrous webs in particular. The reason for this is that in surface DBD the plasma channels are parallel with a substrate surface and plasma is thus in a good contact with the surface. A further advantage of DBD plasma sources is that all surfaces, not only outer surfaces but also inner surfaces, are treated by plasma.

The substrate can be for instance a metal, a glass, a semiconductor, a ceramic, a polymer, a woven or non-woven a fibrous web and even single fibres, yarns or filaments (mono-yarns, mono-filaments), or combinations thereof. Preferably, the substrate is a dielectric substrate. A particularly preferred substrate is a fibrous web. The fibrous web advantageously comprises ultra strong fibre material.

The particles can be in a liquid, in a solid phase, or in a mixed liquid/solid phase and can have an average particle size of 0.005-10 μm. Average particle sizes in the range of 0.1-1 μm are preferred. The average size of particles can for instance be determined by dynamic light scattering. The particles can have any shape, such as spheres, cubes, rods, tubes, but also irregular shapes are possible.

The particles can have for instance an organic, inorganic, organo-metallic, metallic organo-silicon, bioactive, or composite nature. The particles can comprise one or more inorganic elements selected from the group of Ag, Al, As, Ba, Be, Bi, Ca, Cd, Ce, Co, Cr, Cu, Dy, Er, Eu, Fe, Ga, Gd, Ge, Hf, Ho, In, Lu, Mg, Mo, Mn, Nb, Nd, Ni, Pb, Pm, Pr, Sb, Si, Sm, Sn, Sr, Ta, Tb, Ti, Tm, V, W, Yb, Zn, Zr. Preferred oxide particles include for instance Fe₂O₃, TiO₂, HfO₂, Al₂O₃, ZrO₂, ZnO, SiO₂, SnO₂, MgO, ZnO, CuO, and mixtures thereof.

The particles can also comprise organic compounds such as fullerenes, dendrimers, organic polymeric nanospheres (such as polystyrene), insoluble sugars (such as lactose, trehalose, glucose or sucrose), aminoacids, linear or branched or hyperbranched polymers, or combinations thereof. Particularly preferred particles comprising organic compounds are particles comprising rubber, such as natural rubber (cis-1,4-polyisoprene), styrene-butadiene rubber, butyl rubber, ethylene-propylene rubber, ethylene-butylene rubber, polyacrylate rubber, neoprene rubber, nitrile-type rubber, fluoroelastomer, polyurethane rubber, polysulphide rubber, or blends thereof.

Composite particles may also be applied, for instance core-shell particles. Different types of core shell particles include for example particles having a metal core and an organic polymer shell, particles having a ceramic core and an organic polymer shell, and particles having a liquid core and an organic polymer shell.

In a preferred embodiment, the particles comprise or are surrounded by precursors of an elastomer. In the context of this application precursors of an elastomer include monomers or oligomers that can be polymerised and cured to form an elastomer, but also polymers that can be cured to form an elastomer.

The term “polymerising” in this application is meant to refer to the bonding of two or more monomers and/or oligomers to form a polymer. The term “curing” in this application is meant to refer to the toughening or hardening of a polymeric material by cross-linking of polymer chains. The term “cross-linking” in this application is meant to refer to the creation of chemical links between the molecular chains of polymers, but also between the molecular chain of a polymer and a substrate.

Liquid or partly liquid particles may be prepared for instance by using a liquid aerosol generator, e.g. a normal or electrostatic spray nozzle (for micrometer-sized droplets) or so-called “nebulisers” (for sub-micron droplets) can be used. The liquid aerosol generator disperses small droplets/aerosols in a gas flow. A possible liquid/solvent is for instance acetone or styrene. It is also possible that the droplets contain solid particles (e.g. silica) which are smaller than a micron, or even smaller than 100 nm.

If liquid or partly liquid particles are used it is preferred that at least part of the droplets is polymerised, i.e. a controlled part of the liquid in the droplet is transformed into macromolecules. This polymerisation is preferably carried out by a non-thermal plasma treatment. During this treatment it is advantageous if part of the liquid/solvent is evaporated, because this reduces the average particle size and the weight of the particles when attached to the substrate.

Solid phase particles may be prepared by a suitable dispersion method for solid particles, for example fluidised bed. The fluidised bed method is suitable to obtain particles with an average particle size in the range 100 nm-100 micrometer.

It is also possible to prepare solid particles by a non-thermal plasma method. According to such a method, the electron impact of a metal, carbon or silicon containing molecular gas results in a supersaturated vapour, which can be nucleated and condensed to very small particles. This method is suitable to obtain particles with an average particle size of smaller than 100 nm, or even smaller than 10 nm. Possible precursor gases include methane for carbon particles and hexamethyldisiloxane (HMDSO) for silica particles. Disadvantages of this method are the low production rate and the fact that precursor gases may cause undesirable by-products. An advantage of the non-thermal plasma method is that the non-thermal plasma can also be used in the invention to obtain non-agglomerated very small (smaller than 30 nm) nanoparticles, to activate the surface of the plasma-synthesised nanoparticles and coat the particles before deposition of the particles on the substrate.

Another possibility for preparing solid particles is by using thermal plasma, for example repetitive pulsed-plasma-arc induced metal evaporation, inductive coupled plasma evaporation of metal/ceramic powders followed by recondensation into small particles.

Preferably, the particles are at least partially provided with a coating prior to being deposited on the substrate. This is of particular interest for providing an organic binder material with the particles and in the case of non agglomerating particles that do not have the tendency to stick. Preferably, the coating comprises precursors of an elastomer. Preferred precursors are liquid precursors for synthetic rubbers, for example isoprene, styrene, butadiene, butylene, ethylene, propylene, acrylate monomers (such as acrylic acid, butyl acrylate, 2-ethylhexyl acrylate, methyl acrylate, ethyl acrylate, acrylonitrile, n-butanol, methyl methacrylate, and trimethylol propane triacrylate), chloroprene (2-chloro-1,3-butadiene), acrylonitrile, diisocyanate, a polyester (such as glycol-adipic acid ester) or combinations thereof. The coating is provided by condensing a liquid precursor or mixture of precursors or a partially polymerised solid on the surface of the particles.

The coating may be provided onto the particles using a non-thermal plasma process in which the surface of the particles is activated and subsequently coating material is applied by chemical vapour deposition. In the case where the coating material comprises a monomer or oligomer, the polymerisation process can be initiated prior to deposition on the substrate surface.

It is advantageous to keep the time period between the provision of the coating and the deposition of the particles on the substrate very short, typically 0.01-10 ms, preferably 0.1-1 ms so as to minimise or even avoid significant particle agglomeration. Accordingly, the method of the invention involves an improved dispersion of particles.

The substrate can be subjected to a plasma activation prior to deposition of the particles. Plasma activation of the substrate surface comprises hydrogen abstraction, radical formation and introduction of new functional groups from the plasma environment. New functional groups may also be introduced on the substrate surface from the surrounding air after plasma activation. The plasma activation results in a reactive activated surface. Plasma activation can be achieved for instance by using N₂ or CO₂ gasses.

During deposition of the particles on the optionally activated surface of the substrate, the particles are at least physically adsorbed to the surface of the substrate, and preferably chemically bound thereto. In the particular case where the substrate is a fibrous web, the particles are deposited on the surface of the fibres of the fibrous web. In the special embodiment wherein the particles comprise precursors of an elastomer, the particles are chemically linked to the substrate through cross-links that are formed between the optionally activated substrate and the polymers during the deposition step.

Deposition of the particles onto the substrate can involve a plasma treatment, preferably a non-thermal plasma treatment. The plasma treatment results in a polymerisation and/or curing of the optionally present precursors of an elastomer.

In the particular case of liquid particles, that optionally contain an inorganic hard core material, a surplus of liquid (e.g. styrene or acetone) can be evaporated before or after deposition of those particles. The evaporated liquid is transported away from the surface. This avoids undesirable deposition outside the vicinity of the particle.

Though a primary objective of the present invention is to deposit particles to a substrate using an organic binder material added to those particles before deposition so as to avoid the complete covering of that substrate with the binder material, the method of the invention can also be applied to deposit thin layer coatings that cover a substantial part of the substrate surface or cover the substrate entirely. In that particular case the method of the invention allows to achieve much higher deposition rates than obtained with conventional gas phase deposition methods. The deposition rates of the present invention are typically 1-100 nm per second whereas conventional plasma assisted chemical vapour deposition is limited to a 0.01-1 nm per second.

In a special embodiment, the particles consist of one preferably liquid phase monomeric rubber precursor or one preferably liquid phase monomeric rubber is provided on inorganic particles and another preferably gas phase monomeric rubber precursor is provided when depositing the particles on the substrate or even thereafter. This allows the formation of copolymeric rubber particles on the surface. For instance, a particle is provided with a styrene monomer and a butadiene monomer is provided when depositing the particle on the substrate or even thereafter so that the final product is provided with the desirable rubber/elastic properties of styrene-butadiene rubber. Such desirable properties are for instance the elongation without deformation of styrene-butadiene rubber of 400-500% in a temperature range between minus 60° C. and plus 120° C.

In an optional subsequent curing stage, the polymers can be additionally cross-linked. At the same time polymerisation can be further completed. This extra step is advantageous to achieve a desirable degree of polymerisation, a desirable chemical bonding of each particle to the substrate, and the preferable elastomeric properties. The optional curing stage can for instance involve plasma activated cross-linking. However, also other curing methods such as ultraviolet radiation, electron beam radiation, or heat may be used.

Providing the particles to be deposited with a protective coating is particularly interesting in the case of organic functional particles. Conventional gas phase deposition methods often cause a loss of functionality of the deposited particles or chemical agent due to plasma decomposition. Encapsulation of the solid/liquid particles with specific functional properties (such as antimicrobial or flame retardant) can avoid or at least reduce this loss of functionality.

The method of the invention provides advantages that can be employed for various applications, such as improved bonding of particles to a surface, good dispersion of particles over a surface, reduced deposition of binder material, deposition of multiphase or composite heat sensitive particles, deposition of particles to a heat sensitive surface, and high deposition rates.

Applications of the method of the invention are for example the deposition of relatively hard (e.g. polymethylmethacrylate) particles on rubber to reduce friction, the deposition of rubber particles on flat surfaces to increase friction (e.g. anti-slip coatings), the deposition of functionalised particles to obtain anti-fouling coatings on polymeric or other surfaces (e.g. underwater coatings for ships), the deposition of phase change materials on fabrics for thermal management, the deposition of flame retardant particles on fabrics, the deposition of antimicrobial particles (antimicrobial polymer may for instance be encapsulated by a flexible thin coating before deposition to prevent the polymer from plasma dissociation, which is a significant advantage compared to plasma polymerisation of antimicrobial monomers), the deposition of encapsulated particles with liquid core that release their liquid antimicrobial content upon mechanical pressure (e.g. for antimicrobial bandages), the deposition of particles that prevent biofilm formation on medical implants and devices like catheters, the deposition of functionalised particles on polymeric substrates to improve biocompatibility, the immobilisation of biopolymers on plasma-functionalised surfaces, and the method of the invention can be used as an economic deposition technique for manufacturing of solar cells.

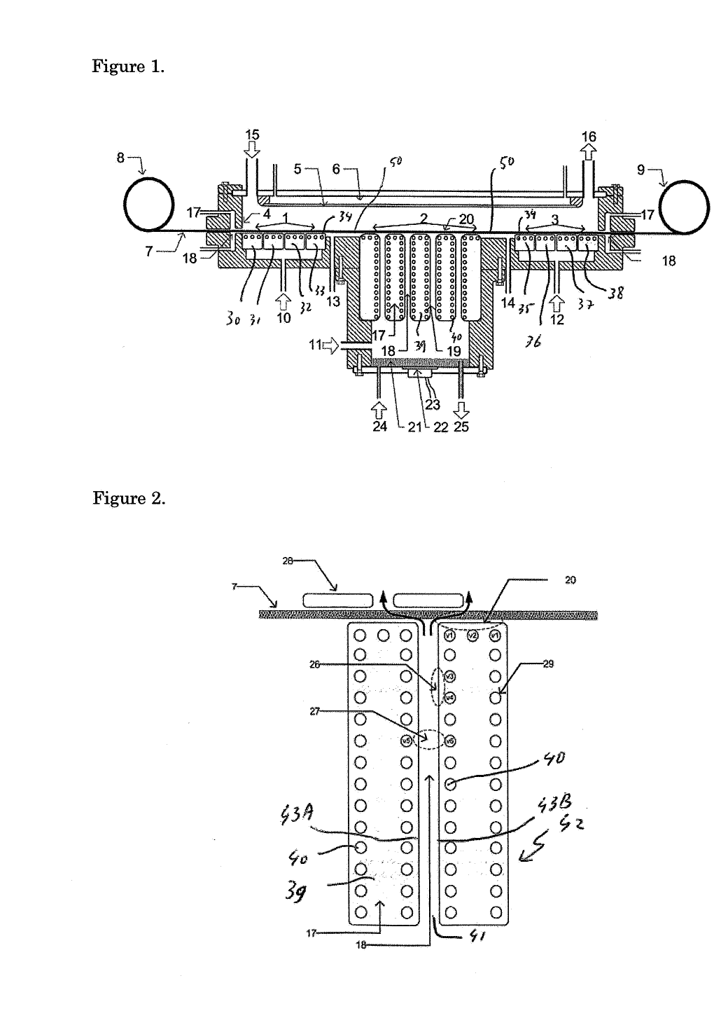

The method of the invention can for example be carried out in a plasma reactor for treatment of substrates as depicted in FIG. 1. The reactor is provided with a first and second winding roll 8, 9 for transporting a substrate 7 along or through a number of plasma zones 1, 2, 3 along a substrate path 50. The plasma zones 1, 2, 3 comprise a plasma generating device for treating the substrate 7. In each zone 1, 2, 3 a specific treatment is carried out. In particular, in a first zone 1 a surface activation can be carried out, in a second zone 2 particles, preferably nanoparticles, are deposited and attached, while in a third zone 3 a final polymerisation and/or cross-linking and strengthening of chemical bond to the substrate can be performed.

It is noted that, in principle, it is not necessary to apply all described plasma zones for treating a substrate 7. As an example, the third zone can be omitted in some cases, e.g. if the attachment action in the second zone 2 appears to meet the physical requirements in a particular application. As a second example, the first zone can be omitted using plasma zone 2 alternately for optional substrate surface activation and particle deposition.

The plasma generating device in each plasma zone 1, 2, 3 comprises a surface dielectric barrier discharge arrangement for treating the substrate 7. A surface dielectric barrier discharge structure comprises a dielectric body 30, 31, 32, 33 wherein an appropriate part of an external surface near the substrate path 50 is covered by electrodes 34. Upon application of electric potentials to the electrodes 34, plasma filaments are generated near a surface between the electrodes 34.

In FIG. 1, the first zone 1 comprises a number of such surface dielectric barrier discharge arrangements with dielectric bodies 30, 31, 32, 33. Similarly, the third zone 3 comprises a number of surface dielectric barrier discharge arrangements having dielectric bodies 35, 36, 37, 38 and electrodes 34.

The second zone 2 shown in FIG. 1 comprises a more complex plasma generating device that is constructed using elementary surface dielectric barrier discharge elements. A number of surface dielectric barrier discharge elements 42 having dielectric bodies 39 that are arranged in parallel defining channels 41 between opposite external surfaces 43A, 43B of adjacent surface dielectric barrier discharge elements 42, the mentioned opposite external surfaces 43A, 43B being at least covered by electrodes 40 as shown in FIG. 2 depicting a schematic cross sectional view of a plasma generating device in zone 2 of the reactor.

Preferably, ends of the dielectric bodies 39 are positioned near the substrate path 50. Optionally, an end surface of the dielectric bodies 39 near the substrate path 50 is provided with electrodes v1, v2 to generate plasma filaments near the substrate 7 to be treated.

By applying voltage potentials to electrodes v3, v4 located on an external single surface 43B a surface plasma filament discharge 26 is generated in the channel 41. Further, by applying a voltage potential to electrodes v5, v6 located on opposite external surfaces 43A, 43B a volume plasma filament discharge 27 is generated in the channel 41. Thus, by driving selected electrodes in the plasma generating device in zone 2 of the reactor, different types of discharges can be generated at pre-selected locations in a particle flow channel 41.

In the particle flow channel 41 particles are flown to the substrate 7 to be treated. If desired, such particles can be pre-treated in the channel 41 as described herein. By generating surface discharges, an instant local increase in temperature is created. Further pressure waves are generated having a frequency according to a voltage frequency that is applied to the electrodes, the frequency being e.g. in a range of approximately 0.1 to 100 kHz. The phenomenon of local temperature increase caused by surface discharges can be used for plasma induced thermophoresis and has the effect that a force is exerted to solid and/or liquid particles driving them away from the surface 43A, 43B of the dielectric bodies 39.

Plasma induced thermophoresis is a known phenomenon in sub-atmospheric pressure radiofrequent plasma glow processing of surfaces where undesirable particle deposition is to be avoided.

Further, the repetitive electrical excitation of the plasma causes repetitive pressure waves near the dielectric barrier surface that causes the release of particles that may have been deposited on the surface 43A, 43B of the bodies 39 in spite of the effect of thermophoresis.

The plasma that is generated by the plasma devices implemented as surface or volume dielectric barrier discharge arrangements is non-thermal and can be operated at atmospheric or super-atmospheric pressure. The typical range of the operating pressure is typically 0.1-10 bar, preferably 0.5-2 bar.

It is noted that also so-called coplanar surface dielectric barrier discharge structures are applicable wherein electrodes are embedded in the dielectric body.

Therefore, in FIGS. 1 and 2 a plasma reactor is shown that is provided with a multiple number of plasma generating devices for performing a plasma activation process and a particles deposition and/or attachment process, respectively, on a substrate along a substrate path, wherein a first plasma generating device comprises a number of aligned surface dielectric barrier discharge arrangements having dielectric bodies wherein an external surface near the substrate path is at least partially covered by electrodes, and wherein a second plasma generating device comprises an assembly of elementary surface dielectric barrier discharge elements having dielectric bodies that are arranged in parallel defining particle flow channels between opposite external surfaces of adjacent surface dielectric barrier discharge elements, the opposite external surfaces being at least partially covered by electrodes.

In a preferred embodiment, ends of the dielectric bodies of the second plasma generating device are positioned near the substrate path 50.

In a further preferred embodiment, in the second plasma generating device, an end surface of the dielectric bodies near the substrate path is provided with electrodes.

In a yet further preferred embodiment, the plasma reactor further comprises a third plasma generating device for performing final cross-linking and strengthening of a chemical bond to the substrate.

In a second aspect, the invention is directed to a fibrous web obtainable by a method according to the invention, comprising fibres and elastomeric particles. This fibrous web comprises particles that are individually attached to the surface of the substrate without deposition of a binder layer which entirely covers the substrate. As a result, the substrate can be provided with particles with a minimum weight increase of the substrate. In addition, particles can be deposited onto the substrate without introducing undesired surface properties caused by an excess of binder material. Furthermore, since in the preferred embodiment of the invention, wherein the particle pre-treatment and the particle deposition are performed in different plasma regions, deposition of material other than the particles during deposition of the particles is avoided.

The inventors have found that the method of the invention can be used to provide a fibrous web having increased friction between the yarns (i.e. strands of fibres) of the web, while the flexibility and the light weight of the material are maintained. The friction between the yarns of the web is also known as inter-yarn friction.

Such a fibrous web is particularly interesting in the field of ballistics. Upon impact of a projectile or fragment, the yarns of a fibrous web slide with respect to each other. The inter-yarn friction is therefore an important parameter in the ballistic protection of the fibrous web.

The inter-yarn friction is significantly increased by the presence of the attached particles. Without wishing to be bound by theory it is believed that the particles are located on the surface of the yarns and hamper the sliding of the yarns with respect to each other. A further increase in inter-yarn friction is achieved by deformation of the attached particles. The deformation may be elastic or inelastic and the combined effect of deformation and friction results in increased energy transfer between the yarns and thus in a better protection against ballistic impacts.

The invention allows protection against both ballistic impact and protection against puncture, or so-called stab protection. These properties can be obtained by using particles with a relatively thick polymeric coating and tailoring the amount of polymer (preferably elastomeric polymer) and the amount of the particle material (preferably inorganic metal and/or ceramic particles). This is advantageous in view of the strong demand for light weight textile materials offering ballistic protection with additional stab protection.

There is no need for deposition of a layer covering most of or the entire fibrous web. It is sufficient to have localised particles that are attached to the fibres. The coverage of the fibre surface, i.e. the relative surface area of the fibres that is covered by the particles, can be relatively low. For example 0.1-10%, preferably 0.5-5% of the surface area of the fibres is covered by particles. Accordingly, there is almost no increase in weight, a minimum loss of flexibility and unchanged gas permeability of the fibrous web.

Polymers formed by the process of plasma polymerisation can have different chemical and physical properties from those formed by conventional polymerisation. Plasma polymerised films can be highly cross-linked and can, therefore, have many appealing characteristics such as thermal stability, chemical inertness, mechanical toughness and negligible ageing. Also the washing-off characteristics can be enhanced.

In a special embodiment, the particles attached to the fibrous web have a hard rigid core (of for example a metal or ceramic material) and an elastomeric shell. The shell comprises a synthetic rubber or other elastomer. The shell can have a thickness of 0.01-1 μm, preferably 0.01-0.1 μm.

Preferably, the synthetic rubber or other elastomer is present in an amount of 0.1-10 wt. %, more preferably 0.1-1 wt. %, based on the dry weight of the fibrous web.

The weight ratio between the core material and the shell material of the core-shell particles in the final fibrous web is preferably 1:10-10:1, more preferably 1:5-1:1.

The particles preferably comprise an elastomer selected from the group of synthetic co-polymer rubbers such as for example styrene-butadiene rubber.

The core-shell particles preferably comprise a core material selected from the group consisting of silica, alumina and titanium dioxide.

### EXAMPLES

### Example 1

In a first set of experiments ultrasonic nebulisers were used in a bath of acetone wherein CuO nanoparticles were dispersed. Needle-like crystalline CuO nanoparticles with a typical length of 20-30 nm and a width of 5 nm were applied. The nebulisers formed an aerosol mist in argon gas above the acetone bath. The aerosol size was typically in the 2-5 μm range. Argon was used as a carrier gas to pass the aerosols through the first plasma region of the apparatus proposed in the invention. The length of the plasma zone in direction of the main gas flow was 100 mm and the residence time of the particles in the plasma region was in the range 0.1-1 s (depending on argon flow). The power transferred to the plasma was typically 20 Watt. The initial temperature of the mixture of argon gas and aerosol mist was 35° C. The gas was not significantly heated by the plasma.

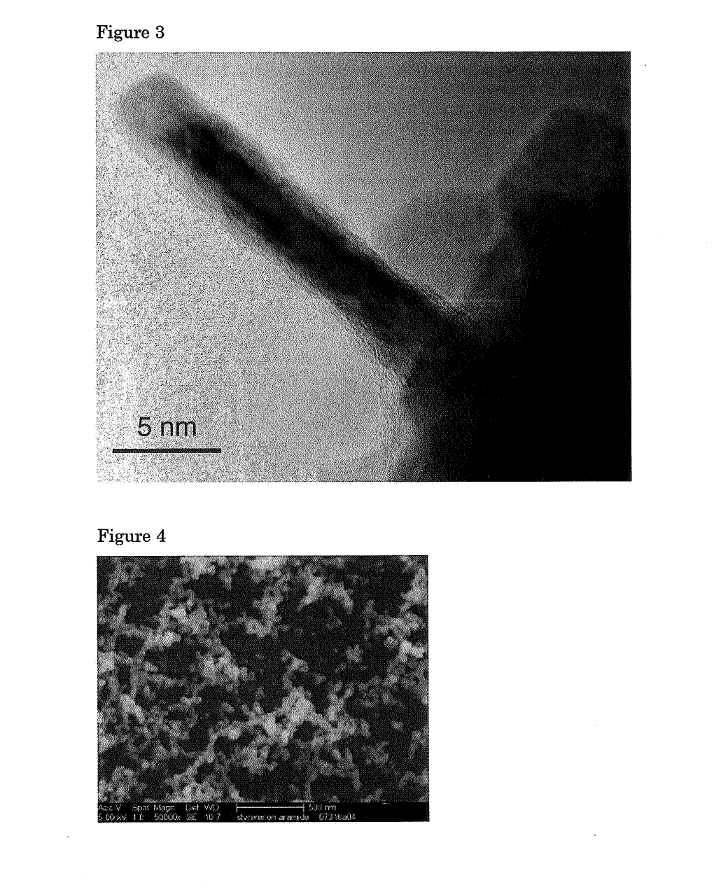

According to our TEM observations of particles deposited on polyethylene fibres, CuO particles were coated by a carbon containing layer (FIG. 3). It has clearly been demonstrated that CuO particles are fully encapsulated by the carboneous layer. Preliminary washing tests in an ultrasonic bath have demonstrated that at least a part of the particles is bound to the polyethylene surface.

### Example 2

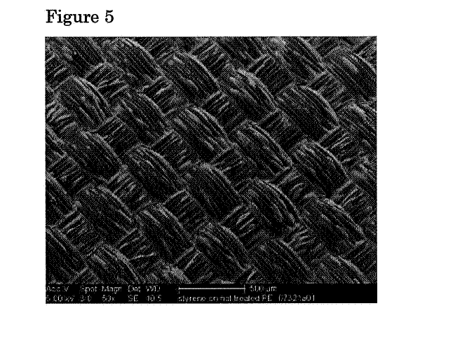

In a second set of experiments, similar experimental conditions (Argon gas flow, plasma power) were used for dispersion of liquid styrene aerosols. In this case it appeared more difficult to disperse particles of the preferred type (SiO₂ and TiO₂ nanoparticles). However, we were able to show the effectiveness of the first plasma region, according to the invention, to form polystyrene nanoparticles and the second plasma region to attach those particles on aramid fibres. The SEM photographs in FIGS. 4 and 5 show the dispersion of those polystyrene particles on aramide fibres (FIG. 4) and the appearance of the woven aramide (body armor material) as a whole (FIG. 5).

FIG. 1. A schematic cross sectional view of a plasma reactor for the treatment of surfaces.

FIG. 2. A schematic cross sectional view of a plasma generating device in zone 2 of the plasma reactor.

FIG. 3. TEM picture of coated CuO particles deposited on polyethylene substrate.

FIG. 4. Dispersion of polystyrene particles on aramide fibres.

FIG. 5. Appearance of woven aramide (body armor material) with polystyrene particles.

1. Method for depositing particles on a substrate, comprising the subsequent steps of
providing particles;
subjecting said particles to a first plasma treatment before being deposited on said substrate; and
depositing said particles on said surface of said substrate using a second plasma treatment.

2. Method according to claim 1, wherein said first plasma treatment and said second plasma treatment are performed in different plasma zones.

3. Method according to claim 1, wherein said surface is subjected to a plasma activation before deposition of said particles.

4. Method according to claim 1, wherein the substrate is subjected to a curing step after the particles have been deposited, which curing step involves plasma activated cross-linking, ultraviolet radiation, electron beam radiation, or heat.

5. Method according to claim 1, wherein said particles comprise at least one precursor of an elastomer prior to deposition on said substrate.

6. Method according to claim 1, wherein the particles are coated before or during deposition of the particles, which coating forms a binder material.

7. Method according to claim 6, wherein said coating comprises at least one precursor for synthetic rubber.

8. Method according to claim 1, wherein the provided particles are at least partly in the liquid phase, and wherein the particles are provided by a liquid aerosol generator.

9. Method according to claim 1, wherein the provided particles are in the solid phase, and wherein the particles are provided by a method selected from the group consisting of a suitable dispersion method, a non-thermal plasma method, and a thermal plasma method.

10. Method according to claim 1, wherein the substrate is selected from the group consisting of a metal, a glass, a semiconductor, a ceramic, a polymer, a woven or non-woven a fibrous web, a single yarn or filament, or combinations thereof.

11. Method according to claim 1, wherein the plasma is generated by surface or volume dielectric barrier discharge arrangements.

12. Method according to claim 1, wherein the plasma is non-thermal and can be operated at atmospheric or super-atmospheric pressure.

13. Fibrous web obtainable by a method according to claim 1, comprising fibres and elastomeric particles.

14. Fibrous web according to claim 13, wherein the particles are in the form of core-shell particles, and wherein the shell comprises an elastomer.

15. Fibrous web according to claim 13, wherein said shell has a thickness of 0.01-1 μm.

16. Fibrous web according to claim 13, wherein said particles have an average particle size of 0.01-10 μm.

17. Fibrous web according to claim 13, wherein 0.1-10%, of the surface area of the fibres is covered by said particles.

18. Fibrous web according to claim 13, wherein the elastomer is present in an amount of 0.1-10 wt. %, based on the dry weight of the fibrous web.

19. Fibrous web according to claim 13, wherein the weight ratio between the core material and the shell material in the fibrous web is 1:10-10:1.

20. Ballistic protection comprising a fibrous web according to claim 13.

21. Ballistic protection according to claim 20, further providing protection against puncture.
